(19) United States
(12) Patent Application Publication
(10) Pub. No.: US 2025/0377705 A1
(43) Pub. Date: Dec. 11, 2025

(54) Process And Temperature-aware Processor low-power mode Selection

(71) Applicant: QUALCOMM Incorporated, San Diego, CA (US)

(72) Inventors: Rohit SINGH, Hyderabad (IN); Venkata Biswanath DEVARASETTY, Hyderabad (IN); Srinivas Rao LENGAMANENI, Hyderabad (IN); Ashok Kumar JANDRAPETA, Hyderabad (IN); Chethan MURARISHETTY, Aler (IN); Maheshwar Thakur SINGH, Hyderabad (IN); Linga Achuta Ram Kumar NIMMALA, Bangalore (IN); Nilesh DHAVLIKAR, Bangalore (IN)

(21) Appl. No.: 18/734,126

(22) Filed: Jun. 5, 2024

(51) Int. Cl. G06F 1/3206; G06F 1/3234

(52) U.S. Cl. CPC G06F 1/3206; G06F 1/3243

(57) ABSTRACT

Various embodiments include a method performed by a processor system of a computing device for managing power modes of the processor system. Embodiments may include identifying a minimum residency time of a low-power mode of the processor system based on actual current leakage at runtime of the processor system, identifying a cost of the low-power mode based in part on the minimum residency time of the low-power mode, determining based on the cost of the low-power mode whether transitioning to the low-power mode will result in cost savings as compared to a cost of operating in at least one other power mode of the processor system, and configuring the processor system for the low-power mode in response to determining that transitioning to the low-power mode will result in cost savings. Cost savings may be energy savings, performance savings, latency savings, or other forms of measurable costs.

### BACKGROUND

Processor power mode management is used to manage costs of and conditions for running processors of a computing device. A processor may be configured in a low-power mode in which the functionality of the processor is significantly limited, such as limited to implementing power mode management functions. Whether to configure the processor for the low-power mode is a decision based on various parameters, as transitioning the processor from a non-low-power mode to a low-power mode incurs costs. The costs of transitioning the processor from the non-low-power mode to the low-power mode may nullify the benefits of the low-power mode compared to the costs and conditions for running the processor in its current operating mode.

### SUMMARY

Various aspects provide methods and apparatuses for implementing such methods for managing power modes of a processor system. Various aspects may include identifying a minimum residency time of at least one low-power mode of the processor system based on current leakage at runtime of the processor system, identifying a cost of the at least one low-power mode of the processor system based in part on the minimum residency time of the at least one low-power mode of the processor system, determining based on the identified cost of the at least one low-power mode whether transitioning to the at least one low-power mode of the processor system will result in cost savings compared to a cost of at least one other power mode of the processor system, and configuring the processor system for the at least one low-power mode of the processor system in response to determining that transitioning to the at least one low-power mode of the processor system will result in cost savings. In some aspects, the cost is energy consumed in transitioning into the low-power mode and operating in the low-power mode for a duration of the minimum residency time.

In some aspects, identifying a minimum residency time of at least one low-power mode of the processor system based on actual current leakage at runtime of the processor system may include identifying the minimum residency time of the at least one low-power mode of the processor system based on the actual current leakage at runtime of the processor system and an operating speed at runtime of the processor system. Some aspects may further include identifying the actual current leakage at runtime of the processor system, and updating the minimum residency time of the at least one low-power mode of the processor system based on the actual current leakage at runtime of the processor system.

Some aspects may further include identifying an expected current leakage of the processor system, and identifying a minimum residency time of the at least one low-power mode of the processor system based on the expected current leakage of the processor system.

Some aspects may further include updating the minimum residency time of the at least one low-power mode of the processor system based on an expected current leakage of the processor system based on the minimum residency time of the at least one low-power mode of the processor system based on the actual current leakage at runtime of the processor system.

In some aspects in which the at least one low-power mode of the processor system includes a first low-power mode and a second low-power mode, determining based on the identified cost of the at least one low-power mode whether transitioning to the at least one low-power mode of the processor system will result in cost savings compared to the cost of the at least one other power mode of the processor system may include determining whether transitioning to the second low-power mode results in an energy savings as compared to transitioning to the first low-power mode, and configuring the processor system for the at least one low-power mode of the processor system in response to determining that transitioning to the at least one low-power mode of the processor system will result in cost savings may include configuring the processor system for the second low-power mode in response to identifying that the cost of the second low-power mode will result in cost savings as compared to transitioning to the first low-power mode.

Some aspects may further include identifying that each of a plurality of processor systems connected to a shared power source are configured in a low-power mode, the plurality of processor systems including the processor system, identifying a remaining time in a minimum residency time of the low-power mode of each of the plurality of processor systems, the minimum residency time of the low-power mode of each of the plurality of processor systems including the minimum residency time of the at least one low-power mode of the processor system, determining whether transitioning to a low-power mode of the shared power source will result in cost savings as compared to transitioning to the low-power mode of each of the plurality of processor systems based on the remaining time in the minimum residency time of the low-power mode of each of the plurality of processor systems, and configuring the shared power source for the low-power mode of the shared power source in response to determining that transitioning to a low-power mode of the shared power source will result in cost savings as compared to transitioning to the low-power mode of each of the plurality of processor systems.

Further aspects include a computing device including a memory and a processor configured to perform operations of any of the methods summarized above. Further aspects include a non-transitory processor system-readable storage medium having stored thereon processor system-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example processor system of the computing device configured for implementing process and temperature-aware processor system low-power mode selection in accordance with various embodiments.

FIG. 3 is a component block and flow diagram illustrating an example idle governor configured for implementing process and temperature-aware processor system low-power mode selection in accordance with various embodiments.

FIG. 4 is a graph diagram illustrating an example of parameters for process and temperature-aware processor system low-power mode selection for implementing various embodiments.

FIG. 5 is a table diagram illustrating an example of parameters for process and temperature-aware processor system low-power mode selection for implementing various embodiments.

FIG. 6 is a process flow diagram illustrating an example method for process and temperature-aware processor system low-power mode selection according to some embodiments.

FIG. 7 is a process flow diagram illustrating an example method for process and temperature-aware processor system low-power mode selection according to some embodiments.

FIG. 8 is a process flow diagram illustrating an example method for process and temperature-aware processor system low-power mode selection according to some embodiments.

FIG. 9 is a component block diagram illustrating an example mobile computing device suitable for implementing various embodiments.

FIG. 10 is a component block diagram illustrating an example mobile computing device suitable for implementing various embodiments.

FIG. 11 is a component block diagram illustrating an example server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and computing devices implementing such methods of implementing process and temperature-aware processor system low-power mode selection. Some embodiments may include identifying a minimum residency time of a low-power mode of the processor system at which cost savings may be realized by transitioning the processor system to the low-power mode. Cost savings may be energy savings, performance savings, latency savings or other forms of measurable costs. In some embodiments, the minimum residency time of the low-power mode may be based on an actual current leakage of the processor system at runtime. In some embodiments, the minimum residency time of the low-power mode may also be based on the operating speed of the processor system at runtime. In some embodiments, the cost is energy consumed in transitioning into and out of the low-power mode and operating in the low-power mode for the duration of the minimum residency time. Some embodiments may include determining whether transitioning the processor system to the low-power mode from a current mode or rather than transitioning to another mode may result in cost (e.g., energy) savings, and configuring the processor system for the low-power mode in response to determining that transitioning the processor system to the low-power mode will result in cost (e.g., energy) savings. Some embodiments may include determining whether transitioning the processor system to the low-power mode will result in cost (e.g., energy) savings based at least in part on the minimum residency time of the low-power mode.

Some embodiments may include identifying that all processor systems connected to a shared power source are configured in a low-power mode. Some embodiments may include determining whether transitioning the shared power source to a low-power mode from a current mode, rather than transitioning to another mode, may result in cost (e.g., energy) savings and configuring the shared power source for the low-power mode. Some embodiments may include determining that transitioning the shared power source to the low-power mode may result in cost (e.g., energy) savings based, at least in part, on the minimum residency time of the low-power mode of the processor systems.

The term “computing device” is used herein to refer to stationary computing devices, including personal computers, desktop computers, all-in-one computers, workstations, supercomputers, mainframe computers, embedded computers (such as in vehicles and other larger systems), computing systems within or configured for use in vehicles, servers, multimedia computers, and game consoles. The terms “computing device” and “mobile computing device” are used interchangeably herein to refer to any one or all of cellular telephones, smartphones, personal or mobile multi-media players, personal data assistants (PDAs), laptop computers, tablet computers, convertible laptops/tablets (2-in-1 computers), smartbooks, ultrabooks, netbooks, palm-top computers, wireless electronic mail receivers, multimedia Internet-enabled cellular telephones, mobile gaming consoles, wireless gaming controllers, and computing systems embedded in vehicles that include a memory, and a programmable processor.

Various embodiments are described in terms of code, e.g., processor system-executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various embodiments.

Processor power mode management is used to manage costs of and conditions for running various processors of a computing device. A processor may be configured in a low-power mode in which the functionality of the processor is significantly limited, such as limited to implementing power mode management functions. Whether to configure the processor for the low-power mode is a decision that is made based on various parameters because transitioning the processor from a non-low-power mode to a low-power mode incurs costs. The costs of transitioning the processor from the non-low-power mode to the low-power mode may nullify the benefits of the low-power mode in terms of the costs and conditions for running the processor.

Time-based parameters are often used for determining whether to configure the processor for a low-power mode, such as an entry latency for transitioning to the low-power mode, an exit latency for transitioning from the low-power mode, and minimum residency time of the low-power mode. These time-based parameters are calculated in a limited manner that fails to account for the variability of the environment and conditions of a running processor. For example, the time-based parameters are typically calculated using the current leakage of the processor at the typical operating speed (or frequency) of the processor in a room-temperature environment.

However, the current leakage of a processor is variably affected by different operating speeds of the processor and temperatures of the processor environment or of the processor components. For example, the current leakage of a processor operating at a faster-than-typical operating speed may be approximately two to three times higher than the current leakage of the processor operating at the typical operating speed. As a further example, the current leakage of the processor operating at a slower-than-typical operating speed may be approximately half to a third of the current leakage of the processor operating at the typical operating speed. As a further example, the current leakage of the processor operating in a warmer than room temperature environment may be up to approximately ten times higher than the current leakage of the processor operating in a room temperature environment.

Failing to account for the variability of the environment and conditions of a running processor in calculating the time-based parameters can lead to inaccurate time-based parameter values, which, if used to determine whether to configure the processor for the low-power mode, could result in an incorrect determination. For example, using inaccurate time-based parameter values could result in configuring the processor for a low-power mode that provides less energy savings or greater energy usage compared to configuring the processor for a different power mode or maintaining the processor in a current power mode.

Various embodiments overcome the preceding problems of inaccurate time-based parameter values and incorrect decisions to configure the processor for a low-power mode. Various embodiments overcome these problems by providing time-based parameters that are identified based on the actual current leakage of a processor system at runtime and using these correct time-based parameters to accurately determine whether to configure the processor system for a low-power mode. In some embodiments, the time-based parameter may be the minimum residency time in the low-power mode. The current leakage may be based on temperatures of the processor system environment or of the processor system components at runtime, such as a transistor junction temperature or operating speeds of the processor system at runtime.

Some embodiments may dynamically adjust a minimum residency time criteria for selecting a low-power mode for each processor system based on the current leakage (or temperature) of the processor system at runtime, which may improve power efficiency and limit temperature increases of the processor system. Some embodiments may adjust a minimum residency time criteria for selecting a low-power mode for each processor system based additionally on the operating speed (or frequency) of the processor system at runtime to further realize the improvements in power efficiency and limit the temperature increases of the processor system. The dynamic adjustment of the minimum residency time criteria for selecting the low-power mode for each processor system may be specific to each processor system and may vary for different processor system types. Some embodiments may consider process and temperature variations that affect the energy or other cost and savings of entering and exiting the low-power mode to further realize the improvements in power efficiency and limit the temperature increases of the processor system.

In some embodiments, a framework module of a processor system may be configured through processor-executable code, firmware, or dedicated circuitry to identify a minimum residency time of one or more low-power modes of the processor system. The framework module may determine the minimum residency time of the one or more low-power modes of the processor system at a boot time based on an expected current leakage of the processor system at a base temperature of the processor system environment or the processor system components. In some embodiments, the framework module may determine the minimum residency time of the one or more low-power modes of the processor system at a boot time, which may be further based on a typical operating speed or frequency of the processor system. The framework module may determine the minimum residency time of the one or more low-power modes of the processor system, which may be specific to the processor system type (e.g., performance level or capabilities of the processor system, model of the processor system, etc.).

The framework module may further identify the minimum residency time of the one or more low-power modes of the processor system at a run time based on an actual current leakage of the processor system. The framework module may determine the minimum current leakage based on the measured temperature of the processor system environment or the processor system components at runtime, such as a transistor junction temperature. In some embodiments, the framework module may determine the current leakage further based on operating speeds or frequencies of the processor system at runtime. Accordingly, the minimum residency time of the one or more low-power modes of the processor system at the run time based on the actual current leakage may be based on the measured temperature of the processor system environment or the processor system components or further on the operating speeds or frequencies of the processor system at the run time. The minimum residency time of the one or more low-power modes of the processor system may be specific to the processor system type.

Identifying the minimum residency time of the one or more low-power modes of the processor system at the boot time or runtime by the framework module may include identifying, such as by calculating, a cost of the one or more low-power modes of the processor system. The cost may be considered in terms of resource use, such as energy, or performance impact, such as latency, of the one or more low-power modes of the processor system. Based on one or more parameters, which may be static or dynamic, the framework module may identify the minimum residency time of the one or more low-power modes of the processor system as a minimum time to potentially realize a benefit from implementing the one or more low-power modes of the processor system. For example, the parameters evaluated by the framework module may include a typical circumstance under which the processor system may operate for implementing the one or more low-power modes. As a further example, the parameters evaluated by the framework module may include the base or measured temperature of the processor system environment or the processor system components, the operating speed or frequency of the processor system, the processor system type of the processor system, the expected or actual current leakage of the processor system, or other information relating to the processor system or typical circumstance.

An idle governor module may be configured through processor-executable code, firmware, or dedicated circuitry to identify whether to implement one or more low-power modes of the processor system. Based on various parameters, including the minimum residency time of the one or more low-power modes of the processor system at boot time or runtime, the idle governor module may determine whether to configure the processor system for one of the one or more low-power modes of the processor system. The idle governor module may receive various parameters, including static and dynamic input parameters. Implementing one or more algorithms, heuristics, etc., the idle governor module may generate a cost of implementing the one or more low-power modes of the processor system and compare the cost of the one or more low-power modes of the processor system with one or more cost thresholds. In some embodiments, the one or more cost thresholds may be one or more preconfigured values. In some embodiments, each of the one or more cost thresholds may be associated with the one or more low-power modes of the processor system. In some embodiments, the one or more cost thresholds may be a cost of one or more of the other power modes of the processor system. In some embodiments, the one or more of other power modes of the processor system may include non-low power modes, active modes, other low-power modes, etc.

The idle governor module may determine whether to configure the processor system for one of the one or more low-power modes of the processor system based on the comparison. For example, the cost of the one or more low-power modes of the processor system not exceeding the one or more cost thresholds may indicate to the idle governor module to implement a low-power mode of the processor system. The idle governor module may configure the processor system for the low-power mode of the processor system in response to the cost of the one or more low-power modes of the processor system not exceeding the one or more cost thresholds. Similarly, in place of the one or more low-power modes of the processor system, the idle governor module may implement functions to benefit the one or more low-power modes of the processor system 204. The idle governor module may configure the processor system 204 for a power mode.

The idle governor module may optionally be configured to identify whether to implement the one or more low-power modes of a shared power source of multiple processor systems. Based on various parameters, the idle governor module may determine whether to configure the power source for a low-power mode of the power source. For example, the parameters may include a power state of each of the multiple processor systems and a time renaming in the minimum residency time of a low-power mode of each of the multiple processor systems. The idle governor module may receive various parameters. Implementing one or more algorithms, heuristics, etc., the idle governor module may determine whether to implement the one or more low-power modes of the shared power source. Of the multiple processor systems sharing the power source, the last of the various processor systems to enter a low-power mode may implement the idle governor module to identify whether to implement the one or more low-power modes of the shared power source. Optionally, the idle governor module may be configured to configure the shared power source of the multiple processor systems 204 for a power mode.

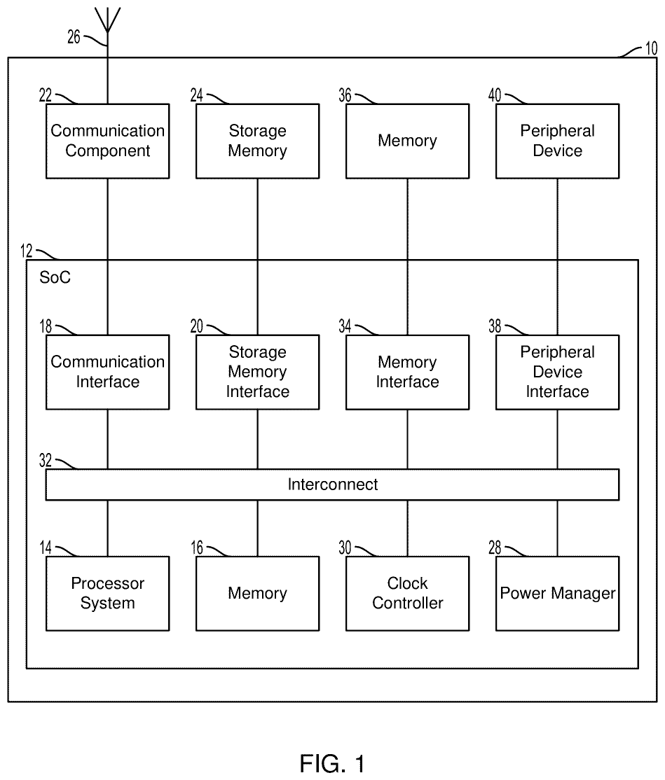

FIG. 1 illustrates a system including a computing device 10 suitable for use with various embodiments. With reference to FIG. 1, the computing device 10 may include a system-on-chip (SoC) 12 with a processor system 14, a memory 16, a communication interface 18, a storage memory interface 20, a memory interface 34, a power manager 28, a clock controller 30, a peripheral device interface 38, and an interconnect 32. The computing device 10 may further include a communication component 22, such as a wired or wireless modem, a storage memory 24, an antenna 26 for establishing a wireless communication link, a memory 36, and a peripheral device 40. The processor system 14 may refer to one or more processing devices, for example, one or more processors or one or more processor cores. The processor system 14 may include any of a variety of processing devices, including multiple processor cores.

The term “system-on-chip” (SoC) is used herein to refer to a set of interconnected electronic circuits typically, but not exclusively, including a processing device, a memory, and a communication interface. A processor system 14 may include a variety of different types of processors and processor cores, such as a general-purpose processor, a central processing unit (CPU), a digital signal processor (DSP), a graphics processing unit (GPU), an accelerated processing unit (APU), a secure processing unit (SPU), an artificial intelligence processing unit (AIPU), a subsystem processor of specific components of the computing device, such as an image processor for a camera subsystem or a display processor for a display, an auxiliary processor, a single-core processor, a multicore processor, a controller, and a microcontroller. A processor system 14 may further embody other hardware and hardware combinations, such as a field programmable gate array (FPGA), an application-specific integrated circuit (ASIC), other programmable logic devices, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processor systems 14. The computing device 10 may include more than one SoC 12, thereby increasing the number of processor systems 14, processors, and processor cores. The computing device ten may also include processor systems 14 that are not associated with an SoC 12. The processor systems 14 may each be configured for specific purposes that may be the same as or different from other processor systems 14 of the computing device 10. One or more of the processor systems 14, processors, or processor cores, of the same or different configurations may be grouped together. A group of processor systems 14, processors, or processor cores may be referred to as a multi-processor system cluster.

The memory 16, 36 for the SoC 12 may be a volatile or nonvolatile memory configured for storing data and processor system executable code for access by the processor system 14. The computing device 10 and/or SoC 12 may include one or more memories 16, 36 configured for various purposes. One or more memories 16, 36 may include volatile memories such as random access memory (RAM) or main memory or cache memory. For example, the memories 16, 36 may include any of static RAM (SRAM), dynamic RAM (DRAM), etc. These memories 16, 36 may be configured to temporarily hold a limited amount of data received from a data sensor or subsystem, data and/or processor system-executable code instructions that are requested from a nonvolatile memory 16, 24, loaded to the memories 16, 36 from the nonvolatile memory 16, 24 in anticipation of future access based on a variety of factors, and/or intermediary processing data and/or processor system-executable code instructions produced by the processor system 14 and temporarily stored for future quick access without being stored in nonvolatile memory 16, 24. The memory 16, 36 may include multiple physical memory components, such as memory chips, that may be logically combined and/or separated to form the memory 16, 36. The memory interface 34 and the memory 36 may work in unison to allow the computing device 10 to load and retrieve data and processor system-executable code on the memory 36.

The storage memory interface 20 and the storage memory 24 may work in unison to allow the computing device 10 to store data and processor system-executable code on a nonvolatile storage medium. The storage memory 24 may be configured much like an embodiment of the memory 16 in which the storage memory 24 may store the data or processor system-executable code for access by one or more of the processor systems 14. The storage memory 24, being nonvolatile, may retain the information after the power of the computing device 10 has been shut off. When the power is turned back on and the computing device 10 reboots, the information stored on the storage memory 24 may be available to the computing device 10. The storage memory 24 may include multiple physical memory components, such as storage memory drives, chips, discs, etc., that may be logically combined and/or separated to form the storage memory 24. The storage memory interface 20 may control access to the storage memory 24 and allow the processor system 14 to read data from and write data to the storage memory 24.

The power manager 28 may be configured to control power states of one or more power rails (not shown) for power delivery to the components of the SoC 12. In some embodiments, the power manager 28 may be configured to control the amounts of power provided to the components of the SoC 12. For example, the power manager 28 may be configured to control connections between components of the SoC 12 and the power rails. As another example, the power manager 28 may be configured to control amounts of power on the power rails connected to the components of the SoC 12. The power manager 28 may be configured as a power management integrated circuit (power management ICs or PMIC).

A clock controller 30 may be configured to control clock signals transmitted to the components of the SoC 12. For example, the clock controller 30 may gate a component of the SoC 12 by disconnecting the component of the SoC 12 from a clock signal and may ungate the component of the SoC 12 by connecting the component of the SoC 12 to the clock signal.

A peripheral device interface 38 may enable components of the SoC 12, such as the processor system 14 and/or the memory 16, to communicate with a peripheral device 40. The peripheral device interface 38 may provide and manage physical and logical connections between the components of the SoC 12 and the peripheral device 40. The peripheral device interface 38 may also manage communication between the components of the SoC 12 and the peripheral device 40, such as by directing and/or allowing communications between transmitter and receiver pairs of the components of the SoC 12 and the peripheral device 40 for a communication. The communications may include the transmission of memory access commands, addresses, data, interrupt signals, state signals, etc. A peripheral device 40 may be any component of the computing device 10 separate from the SoC 12, such as a processor system, a memory, a subsystem, etc. In some embodiments, the peripheral device interface 38 may include a PCIe root complex and may enable PCIe protocol communication between the components of the SoC 12 and the peripheral device 40. In some embodiments, the peripheral device 40 may be a component of the SoC 12.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling the timing and/or transmission paths of the signals.

Some or all of the components, including components of the SoC 12, connected to the SoC 12, and the SoC 12, of the computing device 10 may be arranged differently, separated, and/or combined while still serving the functions of the various embodiments. The computing device 10 may not be limited to one of each of the components, and multiple instances of each component may be included in various configurations of the computing device.

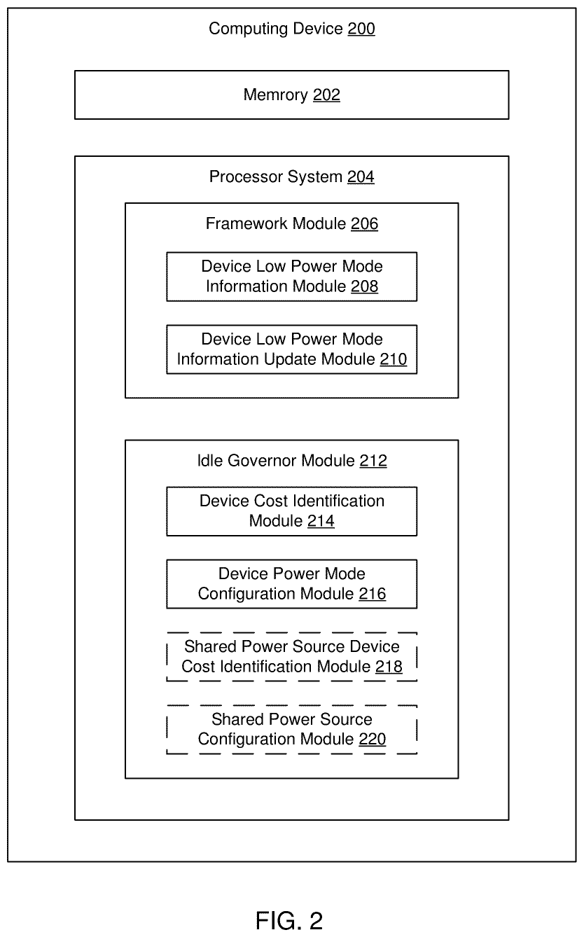

FIG. 2 illustrates an example processor system 204 (e.g., processor system 14 in FIG. 1) of a computing device 200 (e.g., computing device 10 in FIG. 1) configured for implementing process and temperature-aware processor system low-power mode selection for implementing various embodiments. With reference to FIGS. 1-2, the processor system 204 may include a framework module 206 and idle governor module 212, which may each include one or more other modules 208, 210, and 214-220 described further herein. Any one or more of the modules 206-220 may be implemented in hardware, software, firmware, or any combination thereof. In some embodiments, the framework module 206 may be software having one or more modules 208, 210 configured for implementing functions of the framework module 206. In some embodiments, the idle governor module 212 may be software with one or more modules 214-220 configured to implement the idle governor module 212 functions.

The processor system 204 may be configured with processor system-executable instructions of the one or more modules 206-220 for implementing functions of the one or more modules 206-220. The processor system 204 may be an integral component of the SoC (e.g., SoC 12 in FIG. 1) or other components (e.g., processor system 14, memory 16, communication interface 18, storage memory interface 20, memory interface 34, peripheral device interface 38, communication component 22, storage memory 24, memory 36, peripheral device 40 in FIG. 1) of the computing device. The computing device may include a memory 202 (e.g., memory 16, 36, storage memory 24 in FIG. 1) that may be a non-transitory processor system-readable medium storing the processor system-executable instructions of the one or more modules 206-220 for implementing functions of the one or more modules 206-220.

The framework module 206 may be configured to identify a minimum residency time of one or more low-power modes of the processor system 204. The framework module 206 may identify the minimum residency time of the one or more low-power modes of the processor system 204 at a boot time based on an expected current leakage of the processor system 204 at a base temperature of the processor system environment or of the processor system components. In some embodiments, the minimum residency time of the one or more low-power modes of the processor system 204 at a boot time may be further based on a typical operating speed or frequency of the processor system 204. The minimum residency time of the one or more low-power modes of the processor system 204 may be specific to the processor system type (e.g., performance level or capabilities of the processor system, model of the processor system, etc.).

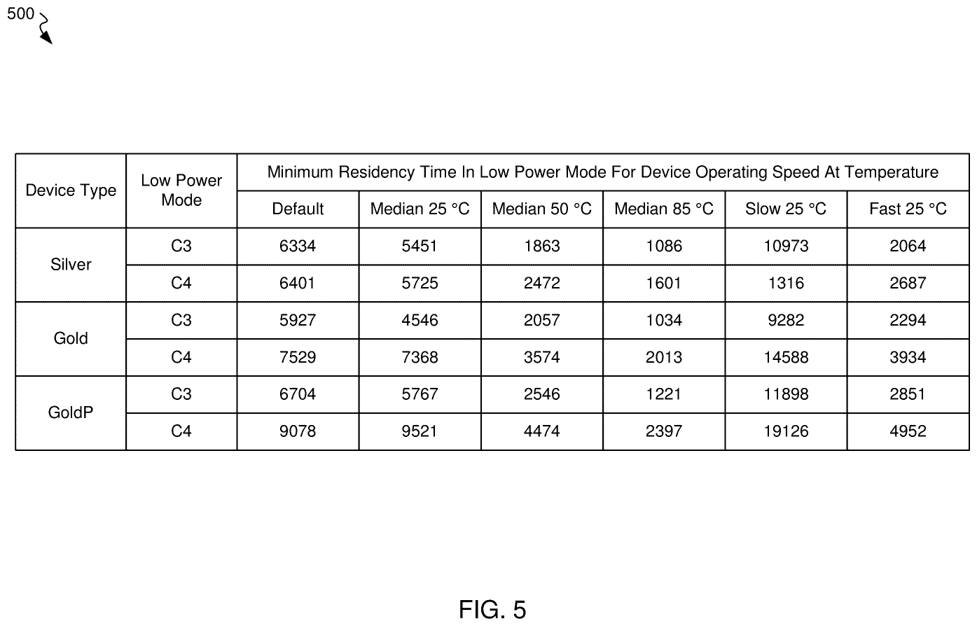

For example, the framework module 206 may include a device low-power mode information module 208 that may be configured to retrieve information from the memory 202 used to identify the minimum residency time of the one or more low-power modes of the processor system 204 at the boot time. In some embodiments, the information retrieved from the memory 202 may be configured to indicate to the processor system 204 the minimum residency time of the one or more low-power modes of the processor system 204. The information may be organized such that the information may be associated with a low-power mode of the processor system 204 at the base temperature of the processor system environment or of the processor system components. In some embodiments, the information may be associated with an operating speed or frequency of the processor system 204. In some embodiments, the information may be associated with the processor system type of the processor system 204. For example, the information may be organized in a data structure, such as a table described herein with reference to FIG. 5.

In some embodiments, the information retrieved from the memory 202 may be information used to identify, such as by calculating, the minimum residency time of the one or more low-power modes of the processor system 204. The information may include any combination of an expected current leakage of the processor system 204 at the base temperature of the processor system environment or of the processor system components, the base temperature, an operating speed or frequency of the processor system 204, or the processor system type of the processor system 204. The device low-power mode information module 208 may implement one or more algorithms to identify, such as by calculating the minimum residency time of the one or more low-power modes of the processor system 204 using the information retrieved from the memory 202. One or more results of identifying the minimum residency time of the one or more low-power modes of the processor system 204 may be illustrated, for example, as one or more values organized in a data structure, such as a table described herein with reference to FIG. 5.

The framework module 206 may further identify the minimum residency time of the one or more low-power modes of the processor system 204 at a run time based on an actual current leakage of the processor system 204. The current leakage may be based on a measured temperature of the processor system environment or of the processor system components at runtime, such as a transistor junction temperature. In some embodiments, the current leakage may be further based on operating speeds or frequencies of the processor system 204 at runtime. Accordingly, the minimum residency time of the one or more low-power modes of the processor system 204 at the run time based on the actual current leakage may be based on the measured temperature of the processor system environment or of the processor system components or further on the operating speeds or frequencies of the processor system 204 at the run time. The minimum residency time of the one or more low-power modes of the processor system 204 may be specific to the processor system type.

For example, the framework module 206 may include a device low-power mode information update module 210 that may be configured to use information associated with the processor system 204 at the run time to identify the minimum residency time of the one or more low-power modes of the processor system 204. The information associated with the processor system 204 at the run time may include any combination of measured temperature of the processor system environment or of the processor system components at runtime, an operating speed or frequency of the processor system 204 at runtime, or the processor system type of the processor system 204.

In some embodiments, the information associated with the processor system 204 at the run time may be retrieved from the memory 202 or identified, such as calculated or measured, at the run time. For example, the device low-power mode information update module 210 may retrieve static information, such as the processor system type of the processor system 204, or configuration information, such as the operating speed or frequency of the processor system 204, from the memory 202. The device low-power mode information update module 210 may identify dynamic information, such as the measured temperature of the processor system environment or of the processor system components, from signals configured to indicate the dynamic information to the processor system. For example, device low-power mode information update module 210 may identify the measured temperature of the processor system environment or of the processor system components from one or more transistor junction temperatures.

The device low-power mode information update module 210 may implement one or more algorithms to identify, such as by calculating the minimum residency time of the one or more low-power modes of the processor system 204 using the information associated with the processor system 204 at the run time. In some embodiments, the device low-power mode information update module 210 may identify the minimum residency time of the one or more low-power modes of the processor system 204 at the run time continuously, periodically, or episodically. For example, the device low-power mode information update module 210 may identify the minimum residency time of the one or more low-power modes of the processor system 204 at the run time based on one changing transistor junction temperatures, based on fractions or whole degrees, including approximately 10° C. One or more results of identifying the minimum residency time of the one or more low-power modes of the processor system 204 may be illustrated, for example, as one or more values organized in a data structure, such as a table described herein with reference to FIG. 5.

In some embodiments, the device low-power mode information update module 210 may be configured to retrieve information from the memory 202 used to identify the minimum residency time of the one or more low-power modes of the processor system 204 at the run time. For example, the device low-power mode information update module 210 may identify the minimum residency time of the one or more low-power modes of the processor system 204 at the run time from the memory 202 based on the information associated with the processor system 204 at the run time. For example, the minimum residency time of the one or more low-power modes of the processor system 204 and the information associated with the processor system 204 at the run time may be organized in a data structure, such as a table described herein with reference to FIG. 5.

Identifying the minimum residency time of the one or more low-power modes of the processor system 204 at the boot time or the run time by the framework module 206 may include identifying, such as by calculating, a cost of the one or more low-power modes of the processor system 204. The cost may be considered in terms of resource use, such as energy, or performance impact, such as latency, of the one or more low-power modes of the processor system 204. In various circumstances, the cost of the one or more low-power modes of the processor system 204 may outweigh a benefit, such as a benefit considered in the same or different terms of the cost, from implementing the one or more low-power modes of the processor system 204. Based on one or more parameters, which may be static or dynamic, the minimum residency time of the one or more low-power modes of the processor system 204 may be a minimum time to potentially realize a benefit from implementing the one or more low-power modes of the processor system 204. For example, the parameters may be for a typical circumstance under which the processor system 204 may operate for implementing the one or more low-power modes. The parameters may include the base or measured temperature of the processor system environment or of the processor system components, the operating speed or frequency of the processor system 204, the processor system type of the processor system 204, the expected or actual current leakage of the processor system 204, or other information relating to the processor system 204 or typical circumstance.

In some embodiments, the device low-power mode information module 208 may identify, such as by calculating, the cost of implementing the one or more low-power modes of the processor system 204 at the boot time based on the information associated with the one or more low-power modes of the processor system 204 at the boot time. The device low-power mode information module 208 may identify the minimum residency time of the one or more low-power modes of the processor system 204 at the boot time for which the benefit of implementing the one or more low-power modes of the processor system 204 outweighs the cost of implementing the one or more low-power modes of the processor system 204.

In some embodiments, the device low-power mode information update module 210 may identify, such as by calculating, the cost of implementing the one or more low-power modes of the processor system 204 at the run time based on the information associated with the one or more low-power modes of the processor system 204 at the run time. The device low-power mode information update module 210 may identify the minimum residency time of the one or more low-power modes of the processor system 204 at the run time for which the benefit of implementing the one or more low-power modes of the processor system 204 outweighs the cost of implementing the one or more low-power modes of the processor system 204.

The idle governor module 212 may be configured for identifying whether to implement the one or more low-power modes of the processor system 204. Based on various parameters, including the minimum residency time of the one or more low-power modes of the processor system 204 at boot time or at runtime, the idle governor module 212 may determine whether to configure the processor system for one of the one or more low-power modes of the processor system 204. The idle governor module 212 may receive the various parameters, including static input parameters and dynamic input parameters. Implementing one or more algorithms, heuristics, etc., the idle governor module 212 may generate a cost of implementing the one or more low-power modes of the processor system 204 and compare the cost of the one or more low-power modes of the processor system 204 with one or more cost thresholds. In some embodiments, the one or more cost thresholds may be one or more preconfigured values. In some embodiments, each of the one or more cost thresholds may be associated with the one or more low-power modes of the processor system 204. In some embodiments, the one or more cost thresholds may be a cost of one or more of the other power modes of the processor system 204. In some embodiments, the one or more of other power modes of the processor system 204 may include non-low power modes, active modes, other low-power modes, etc.

The idle governor module 212 may determine whether to configure the processor system 204 for one of the one or more low-power modes of the processor system 204 based on the comparison. For example, the cost of the one or more low-power modes of the processor system 204 not exceeding the one or more cost thresholds may indicate to the idle governor module 212 that a low-power mode of the processor system 204 should be implemented. The idle governor module 212 may configure the processor system 204 for the low-power mode of the processor system 204 in response to the cost of the one or more low-power modes of the processor system 204 not exceeding the one or more cost thresholds.

Similarly, in place of the one or more low-power modes of the processor system 204, the idle governor module 212 may implement functions to benefit the one or more low-power modes of the processor system 204. For example, the idle governor module 212 may configure the processor system 204 for the low-power mode of the processor system 204 in response to the benefit of the one or more low-power modes of the processor system 204 equaling or exceeding the benefit of the one or more of other power modes of the processor system 204. In some embodiments, the benefit may be considered in terms of resource use, such as energy, or performance impact, such as latency, of the one or more low-power modes of the processor system 204.

For example, the idle governor module 212 may include a device cost identification module 214 that may be configured to identify the cost or benefit of the processor system 204 implementing the one or more low-power modes of the processor system 204 based on the static input parameters and the dynamic input parameters. The static input parameters may be retrieved from the memory 202, received from a component of the computing device, or calculated by the idle governor module 212.

The static input parameters may include, for example, entry latency and exit latency of the one or more low-power modes of the processor system 204, the minimum residency time of the one or more low-power modes of the processor system 204, a power down state, a timer functionality, a cost of the one or more low-power modes of the processor system 204, etc. The power down state indicates whether a particular low power mode keeps the core in a power collapse state or not (such as a retention or clock gating mode). The timer functionality indicates whether, in a particular low-power mode, the per-core timer will be functional or not. Depending on the circumstance during which the idle governor module 212 is implemented, the minimum residency time of the one or more low-power modes of the processor system 204 may be identified based on the information at boot time or the information at runtime. For example, in most cases, the minimum residency time of the one or more low-power modes of the processor system 204 at runtime may be used as it is more likely than not that an update of the minimum residency time of the one or more low-power modes of the processor system 204 has been triggered. The cost of the one or more low-power modes of the processor system 204 may be identified by the framework module 206.

The dynamic input parameters may include, for example, a scheduler sleep length, a power management quality of service (PM QoS), a prediction of low-power mode states, an enabled state, etc. The dynamic input parameters may be use-case-specific and different for different use cases. The dynamic input parameters may be provided to the idle governor module 212 from the memory 202, hardware, firmware, software, etc., specifically for the use case.

The device cost identification module 214 may identify, such as by calculating, a cost of implementing the one or more low-power modes of the processor 204 based on the static input parameters and the dynamic input parameters. The cost of implementing the one or more low-power modes of the processor 204 identified by the device cost identification module 214 may differ from that identified by the framework module 206. For example, the cost of implementing the one or more low-power modes of the processor 204 identified by the framework module 206 may not consider one or more of the static input parameters or the dynamic input parameters. As such, the cost of implementing the one or more low-power modes of the processor 204 identified by the framework module 206 may be a generally applicable in all instances. The cost of implementing the one or more low-power modes of the processor 204 identified by the device cost identification module 214 based on the static input parameters or the dynamic input parameters may be a use case tailored.

The device cost identification module 214 may determine whether the cost of implementing the one or more low-power modes of the processor 204 will result in a cost (e.g., energy) savings as compared to the one or more cost thresholds. For example, the device cost identification module 214 may determine whether the cost of implementing the one or more low-power modes of the processor 204 (i.e., transitioning into and out of the low-power mode and operating in the low-power mode for the duration of the minimum residency time) will result in a savings as compared to the one or more of other power modes of the processor system 204. In some embodiments, the savings may be in terms of resource use, such as energy, or performance impact, such as latency, of the one or more low-power modes of the processor system 204 in comparison to the one or more of other power modes of the processor system 204. The one or more of other power modes of the processor system 204 may include any power modes of the processor system 204, such as non-low power modes, active modes, low-power modes, etc. In response to determining that implementing a low-power mode of the processor system 204 will result in a savings compared to the one or more cost thresholds, the device cost identification module 214 may select the low-power mode of the processor system 204 for implementation.

In some embodiments, multiple low-power modes of the processor system 204 may be identified as resulting in savings compared to the one or more cost thresholds. The device cost identification module 214 may be configured to select one of the low-power modes of the processor system 204 to implement. For example, the low-power modes of the processor system 204 to implement may be selected based on the greatest savings compared to the other savings for other low-power modes of the processor system 204. low-power modes of the processor system 204 may not always have the greatest savings compared to the one or more other power modes of the processor device 204. For example, the costs for implementing the low-power modes of the processor system 204 may outweigh the benefits of implementing one or more of the low-power modes of the processor system 204 based on a use case. For no cost of implementing a low-power mode of the processor system 204 identified as resulting in savings compared to the one or more cost thresholds, the device cost identification module 214 may select to remain in a current power mode.

The idle governor module 212 may be configured to configure the processor system 204 for a power mode. For example, the idle governor module 212 may include a device power mode configuration module 216 that may be configured to configure the processor system 204 for a power mode. Based on the power mode of the processor system 204 selected for implementation, the device power mode configuration module 216 may configure appropriate hardware or software settings to configure the power mode of the processor system 204. For example, to transition the processor system 204 from a current power mode of the processor system 204 to the low-power mode of the processor system 204, the device power mode configuration module 216 may configure appropriate hardware or software settings to configure the low-power mode of the processor system 204. To maintain the processor system 204 in the current power mode of the processor system 204, the device power mode configuration module 216 may configure appropriate hardware or software settings to configure the current power mode of the processor system 204 or make no configuration changes to the appropriate hardware or software settings.

The idle governor module 212 may optionally be configured for identifying whether to implement the one or more low-power modes of a shared power source (not shown) of multiple processor systems 204. Based on various parameters, the idle governor module 212 may determine whether to configure the power source for low-power modes of the power source. For example, the parameters may include a power state of each of the multiple processor systems 204 and a time renaming in the minimum residency time of a low-power mode of each of the multiple processor systems 204. The idle governor module 212 may receive the various parameters. Implementing one or more algorithms, heuristics, etc., the idle governor module 212 may determine whether to implement the one or more low-power modes of the shared power source. Of the multiple processor systems 204 sharing the power source, the last of the multiple processor systems 204 to enter a low-power mode may implement the idle governor module 212 to identify whether to implement the one or more low-power modes of the shared power source.

For example, the idle governor module 212 may include a shared power source device cost identification module 218 that may be configured to identify whether to implement the one or more low-power modes of the shared power source of the multiple processor systems 204. The shared power source device cost identification module 218 may identify a power mode of each of the multiple processor systems 204 sharing the power source. In some embodiments, the shared power source device cost identification module 218 may retrieve power mode information for the multiple processor systems 204 from the memory 202. Based on the power mode information for the multiple processor systems 204, the shared power source device cost identification module 218 may identify the power mode of each of the multiple processor systems 204 sharing the power source. In some embodiments, the shared power source device cost identification module 218 may signal each of the multiple processor systems 204 sharing the power source and identify the power mode of each of the multiple processor systems 204 based on a response from each of the multiple processor systems 204.

To consider implementing the one or more low-power modes of the shared power source of the multiple processor systems 204, the shared power source device cost identification module 218 may determine whether the power mode of all of the multiple processor systems 204 sharing the power source is a low-power mode. For all of the multiple processor systems 204 sharing the power source in a low-power mode, the shared power source device cost identification module 218 may identify a time remaining in the low-power mode for each of the multiple processor systems 204 sharing the power source. The time remaining in the low-power mode may be a time remaining in the minimum residency time for the low-power mode for each of the multiple processor systems 204 sharing the power source. In some embodiments, the shared power source device cost identification module 218 may retrieve the time remaining in the low-power mode for each of the multiple processor systems 204 sharing the power source from the memory 202. In some embodiments, the shared power source device cost identification module 218 may signal each of the multiple processor systems 204 sharing the power source and identify the time remaining in the low-power mode of each of the multiple processor systems 204 based on a response from each of the multiple processor systems 204.

Based at least in part on the time remaining in the low-power mode of each of the multiple processor systems 204 sharing the power source, the shared power source device cost identification module 218 may determine whether the cost of implementing the one or more low-power modes of the shared power source of the multiple processor systems 204 may resulting in savings. The savings may be, for example, as compared to not implementing the one or more low-power modes of the shared power source. For example, the savings may be in terms of resource use, such as energy, or performance impact, such as latency, of the one or more low-power modes of the processor system 204 compared to the one or more low-power modes of the shared power source.

In some embodiments, identifying whether the cost of implementing the one or more low-power modes of the shared power source of the multiple processor systems 204 may result in savings based on the shortest time remaining in the low-power mode for one or more of the multiple processor systems 204 sharing the power source. In some embodiments, identifying whether the cost of implementing the one or more low-power modes of the shared power source may result in savings may be based on a statistical representation of the time remaining in the low-power mode for one or more of the multiple processor systems 204 sharing the power source. The shared power source device cost identification module 218 may determine whether there result in savings by implementing the one or more low-power modes of the shared power source during the time remaining in the low-power mode for one or more of the multiple processor systems 204 sharing the power source. For the cost of implementing a low-power mode of the shared power source identified as resulting in savings, the shared power source device cost identification module 218 may select the low-power mode of the shared power source for implementation.

The idle governor module 212 may be configured to configure the shared power source of the multiple processor systems 204 for a power mode. For example, the idle governor module 212 may include a shared power source configuration module 220 that may be configured to configure the shared power source of the processor systems 204 for a power mode. Based on the power mode of the shared power source selected for implementation, the shared power source configuration module 220 may configure appropriate hardware or software settings to configure the power mode of the shared power source. For example, to transition the shared power source from the current power mode of the shared power source to the low-power mode of the shared power source, the shared power source configuration module 220 may configure appropriate hardware or software settings to configure the low-power mode of the shared power source. To maintain the shared power source in the current power mode of the shared power source, the shared power source configuration module 220 may configure appropriate hardware or software settings to configure the current power mode of the shared power source or make no configuration changes to the appropriate hardware or software settings.

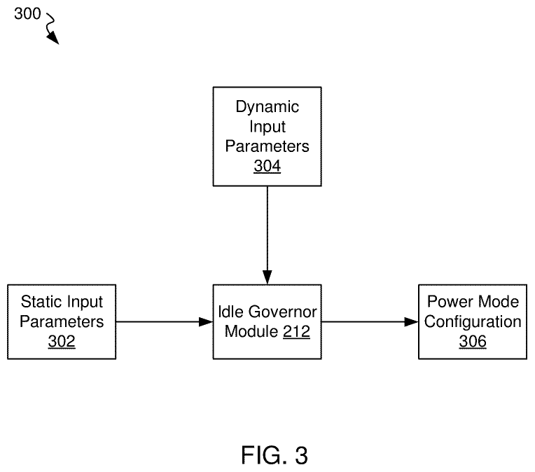

FIG. 3 illustrates an example idle governor module 212 configured for implementing process and temperature-aware processor system low-power mode selection for implementing various embodiments. With reference to FIGS. 1-3, the idle governor module 212 may be implemented in hardware, software, firmware, or any combination thereof of a processor system 300 (e.g., processor system 14, 204 in FIGS. 1 and 2) if a computing device (e.g., computing device 10, 200 in FIGS. 1 and 2). The idle governor module 212 may be configured for identifying whether to implement and configure the processor system 300 for one or more low-power modes of the processor system 300.

The idle governor module 212 may receive various parameters, including static input parameters 302 and dynamic input parameters 304. The static input parameters 302 may include, for example, entry latency and exit latency of one or more low-power modes of the processor system 300, a minimum residency time of the one or more low-power modes of the processor system 300 at boot time or at runtime, a power down state, a timer functionality, a cost of the one or more low-power modes of the processor system 300, etc. Depending on the circumstances during which the idle governor module 212 is implemented, the minimum residency time of the one or more low-power modes of the processor system 300 may be identified based on information at boot time or information at runtime. The static input parameters 302 may be retrieved from a memory (e.g., memory 16, 36, 202 in FIGS. 1 and 2), received from a component of the computing device, or calculated by the idle governor module 212. The dynamic input parameters may include, for example, a scheduler sleep length, a performance metric (PM) quality of service (QoS), a prediction of low-power mode states, an enabled state, etc. The dynamic input parameters may be use-case-specific and may be different for different use cases. The dynamic input parameters may be provided to the idle governor module 212 from the memory, hardware, firmware, software, etc., specifically for the use case.

Implementing one or more algorithms, heuristics, etc., the idle governor module 212 may generate a cost of implementing the one or more low-power modes of the processor system 204 based on one or more of the static parameter inputs 302 and the dynamic parameter inputs 304. The idle governor module 212 may compare the cost of the one or more low-power modes of the processor system 300 with the one or more cost thresholds. The cost of the one or more low-power modes of the processor system 300 not exceeding the one or more cost thresholds may indicate there would be a cost savings or benefit from implementing the one or more low-power modes of the processor system 300.

The idle governor module 212 may determine whether to configure the processor system 300 for one of the one or more low-power modes of the processor system 300 based on the comparison. For example, the cost of the one or more low-power modes of the processor system 300 not exceeding the one or more cost thresholds may indicate to the idle governor module 212 to implement a low-power mode of the processor system 300. The idle governor module 212 may select the low-power mode of the processor system 204 achieving the criteria for the comparison for implementation.

The idle governor module 212 may configure the processor system 300 for the low-power mode of the processor system 204 selected based on the low-power mode of the processor system 300 achieving the criteria for the comparison for implementation. Based on the power mode of the processor system 300 selected for implementation, idle governor module 212 may generate a power mode configuration 306 to configure appropriate hardware or software settings to configure the power mode of the processor system 300.

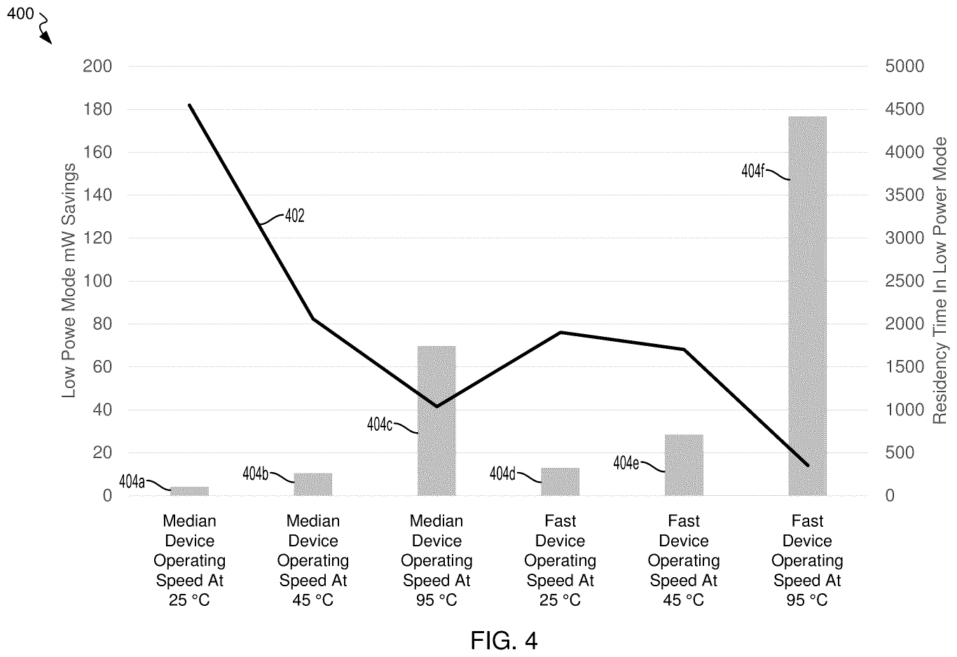

FIG. 4 illustrates an example of parameters for process and temperature-aware processor system low-power mode selection for implementing various embodiments. With reference to FIGS. 1-4, a graph 400 illustrates an example of the relationships between parameters of a processor system (e.g., processor system 14, 204, 300 in FIGS. 1-3) of a computing device (e.g., computing device 10, 200 in FIGS. 1 and 3) for identifying whether to implement a low-power mode of the processor system.

The graph 400 includes a plot 402 of minimum residency times of the low-power mode of the processor system for various temperatures of the processor system environment or of the processor system components and operating speeds or frequencies of the processor system. The plot 402 of minimum residency times of the low-power mode of the processor system may be measured against the axis labeled “Residency Time In low-power mode.” The values of the “Residency Time In low-power mode” axis may represent measurements of time in any unit of time, such as nanoseconds, microseconds, milliseconds, etc.

The graph 400 also includes plots 404a-404f of energy saving by implementing the low-power mode of the processor system for at least the associated minimum residency times of the low-power mode of the processor system. The plots 404a-404f of energy saving by implementing the low-power mode of the processor system may be measured against the axis labeled “Low Power Mode mW Savings.” The values of the “Low Power Mode mW Savings” axis are represented by measurements of power in milliwatt (mW) units but may be expressed in any units of power, current, voltage, etc.

The graph 400 example is meant to illustrate possible parameter relationships, and the specification and claims are not limited to any aspect of the graph 400 example. For example, any of the values in the graph 400 example may be higher or lower, have different ratios between them, or have a distribution of values of the same or different types, etc.

In the example graph 400, the processor system with a temperature at approximately 25° C. and operating at a typical, such as median, operating speed or frequency for the processor system may realize savings of approximately 5 mW 404a in the low-power mode for a minimum residency time of approximately 4500 milliseconds (mS). The processor system with a temperature of approximately 45° C. and operating at a median speed or frequency for the processor system may realize savings of approximately 10 mW 404b in the low-power mode for a minimum residency time of approximately 2000 mS. The processor system with a temperature of approximately 95° C. and operating at a median speed or frequency for the processor system may realize savings of approximately 70 mW 404c in the low-power mode for a minimum residency time of approximately 1000 mS. The processor system with a temperature of approximately 25° C. and operating at a fast speed or frequency may realize savings of approximately 15 mW 404d in the low-power mode for a minimum residency time of approximately 2000 mS. The processor system with a temperature of approximately 45° C. and operating at a fast speed or frequency for the processor system may realize savings of approximately 30 mW 404e in the low-power mode for a minimum residency time of approximately 1750 mS. The processor system with a temperature of approximately 95° C. and operating at a fast speed or frequency may realize savings of approximately 175 mW 404f in the low-power mode for a minimum residency time of approximately 300 mS.

The example graph 400 illustrates that, in some embodiments, under consistent circumstances, greater energy savings may be realized as temperatures of the processor system environment or of the processor system components increase at lower minimum residency times of the low-power mode of the processor system. The consistent circumstances may include the processor system implementing the same low-power mode when operating at the same operating speed or frequency of the processor system.

FIG. 5 illustrates an example of parameters for process and temperature-aware processor system low-power mode selection for implementing various embodiments. With reference to FIGS. 1-5, table 500 illustrates an example of information on which a processor a processor system (e.g., processor system 14, 204, 300 in FIGS. 1-3) of a computing device (e.g., computing device 10, 200 in FIGS. 1 and 3) may determine whether to implement a low-power mode of the processor system.

The example of the table 500 is meant to be illustrative of possible information and organization thereof, and the specification and claims are not limited to any aspect of the example of the table 500. For example, any of the values in the example of the table 500 may be higher, lower, of different ratios between or distribution of values of the same or different types, of different correlation or association (including but not limited to processor system (device) type or low-power mode), etc.

The example of the table 500 includes information for various processor system types in the “Device Type” column. For example, the processor system types are labeled “Silver,” “Gold,” and “GoldP,” which may be indicative of the power or performance capabilities of the processor systems of the processor system types. The example of table 500 also includes information for various low-power modes of the processor systems in the “Low Power Mode” column. For example, the low-power modes of the processor systems are labeled “C3” and “C4,” for which a greater number in the label may indicate a greater extent of low-power operation. The remainder of the example of table 500 includes information on the minimum residency time in a low-power mode for the processor system operating speed at a temperature in the columns under the heading “Minimum Residency Time In low-power mode For Device Operating Speed At Temperature.” The columns may include a “Default” column, which may include the minimum residency time in a low-power mode for the processor system at boot time, for which the operating speed and temperature may be expected values. The remaining columns are labeled with an operating speed and temperature at runtime corresponding to the actual values of the processor system. In some embodiments, the remaining columns are labeled with an operating speed and temperature at runtime and may be populated with information identified by the idle governor module (e.g., idle governor module 212 in FIGS. 2 and 3) at runtime of the processing system.

The example table 500 illustrates that, in some embodiments, that for a same processor system at a same low-power mode and operating speed or frequency of the processor system, the minimum residency times of the low-power mode reduce as temperature increases. Further, for the same processor system at the same low-power mode of the processor system and temperature, the minimum residency times of the low-power mode increase for a slower operating speed or frequency of the processor system and reduce for a faster operating speed or frequency of the processor system.

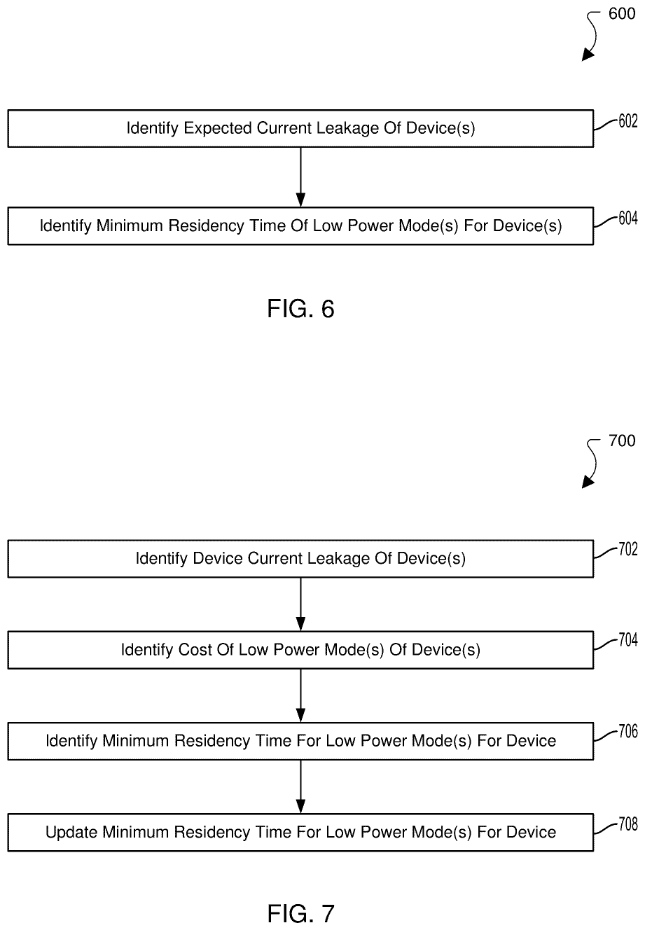

FIG. 6 illustrates an example method for process and temperature-aware processor system low-power mode selection according to some embodiments. With reference to FIGS. 1-6, the method 600 may be implemented in a computing device (e.g., computing device 10, 200 in FIGS. 1 and 2), in hardware (e.g., modules 206-220 in FIGS. 2 and 3), in software (e.g., modules 206-220 in FIGS. 2 and 3) executing in a processor system (e.g., processor system 14, 204, 300 in FIGS. 1-3), or in a combination of a software-configured processor and dedicated hardware, that includes other individual components, such as various memories/caches (e.g., memory 16, 36, 202 in FIGS. 1 and 2). In order to encompass the alternative configurations enabled in various embodiments, the hardware implementing the method 600 is referred to herein as a “processor system device.”

In block 602, the processor system device may identify an expected current leakage of one or more devices (or processor systems) (e.g., processor system 14, 204, 300 in FIGS. 1-3). In some embodiments, the processor system device may retrieve the expected current leakage of the one or more devices from a memory (e.g., memory 16, 36, 202 in FIGS. 1 and 2) at a boot time. In some embodiments, the processor system device may calculate the expected current leakage of the one or more devices based on information retrieved from the memory at the boot time. The expected current leakage of the one or more devices may be based on a base temperature of one or more device environments or of one or more device components. The expected current leakage of the one or more devices may be based on one or more typical operating speeds or frequencies of the one or more devices. In some embodiments, the processor system device identifying the expected current leakage of the one or more devices in block 602 may include a processor system (e.g., processor system 14, 204, 300 in FIGS. 1-3), a framework module (e.g., framework module 206 in FIG. 2), or a device low-power mode information module (e.g., device low-power mode information module 208 in FIG. 2).

In block 604, the processor system device may identify a minimum residency time of one or more low-power modes of the one or more devices. In some embodiments, the processor system device may retrieve the minimum residency time of the one or more low-power modes of the one or more devices from the memory at the boot time. In some embodiments, the processor system device may calculate the minimum residency time of the one or more low-power modes of the one or more devices based on the expected current leakage of the one or more devices. In some embodiments, the processor system device identifying the minimum residency time of the one or more low-power modes of the one or more devices in block 604 may include the processor system, the framework module, or the device low-power mode information module.

FIG. 7 illustrates an example method for process and temperature-aware processor system low-power mode selection according to an embodiment. With reference to FIGS. 1-7, the method 700 may be implemented in a computing device (e.g., computing device 10, 200 in FIGS. 1 and 2), in hardware (e.g., modules 206-220 in FIGS. 2 and 3), in software (e.g., modules 206-220 in FIGS. 2 and 3) executing in a processor system (e.g., processor system 14, 204, 300 in FIGS. 1-3), or in a combination of a software-configured processor and dedicated hardware, that includes other individual components, such as various memories/caches (e.g., memory 16, 36, 202 in FIGS. 1 and 2). In order to encompass the alternative configurations enabled in various embodiments, the hardware implementing the method 700 is referred to herein as a “processor system device.”

In block 702, the processor system device may identify an actual device current leakage of one or more devices (or processor systems) (e.g., processor system 14, 204, 300 in FIGS. 1-3). In some embodiments, the processor system device may calculate the actual current leakage of the one or more devices based on information retrieved from a memory (e.g., memory 16, 36, 202 in FIGS. 1 and 2) or received from a component of the computing device at runtime. The information may include a measured temperature of one or more device environments or of one or more device components, such as a transistor junction temperature. In some embodiments, the information may include one or more operating speeds or frequencies of the one or more devices. In some embodiments, the processor system device identifying the actual device current leakage of the one or more devices in block 702 may include a processor system (e.g., processor system 14, 204, 300 in FIGS. 1-3), a framework module (e.g., framework module 206 in FIG. 2), or a device low-power mode information module (e.g., device low-power mode information module 208 in FIG. 2).

In block 704, the processor system device may identify a cost of one or more low-power modes of the one or more devices. In some embodiments, the processor system device identifying the cost of the one or more low-power modes of the one or more devices in block 704 may include the processor system, the framework module, the device low-power mode information module, or a low-power mode information update module (e.g., low-power mode information update module 210 in FIG. 2). The cost of the one or more low-power modes of the one or more devices may be considered in terms of resource use, such as energy, or performance impact, such as latency, of implementing the one or more low-power modes of the one or more devices. In some embodiments, the cost may be energy consumed in transitioning into and out of the low-power mode and operating in the low-power mode for the duration of the minimum residency time. The cost of the one or more low-power modes of the one or more devices may be the cost of implementing the one or more low-power modes of the one or more devices at a boot time or at a run time.

Identifying the cost of one or more low-power modes of the one or more devices at runtime may be based on the information associated with the one or more low-power modes of the one or more devices at the boot time. The information associated with the one or more low-power modes of the one or more devices at the boot time may include entry and exit latencies, base temperature of one or more device environments or of one or more device components, typical operating speeds or frequencies of the one or more devices, expected current leakage of the one or more devices, etc.

Identifying the cost of one or more low-power modes of the one or more devices at runtime may be based on the information associated with the one or more low-power modes of the one or more devices in real time. The information associated with the one or more low-power modes of the one or more devices in real time may include entry and exit latencies, measured temperature of one or more device environments or of one or more device components, operating speeds or frequencies of the one or more devices, actual current leakage of the one or more devices, etc.

In block 706, the processor system device may identify a minimum residency time for the one or more low-power modes of the one or more devices. The processor system device may identify the minimum residency time of the one or more low-power modes of the one or more devices at the boot time or the run time. The minimum residency time of the one or more low-power modes of the one or more devices may be a period at which a benefit of implementing the one or more low-power modes outweighs the cost of implementing the one or more low-power modes. In some embodiments, the processor system device identifying the minimum residency time for the one or more low-power modes of the one or more devices in block 706 may include the processor system, the framework module, the device low-power mode information module, or the low-power mode information update module.

In block 708, the processor system device may update the minimum residency time for the one or more low-power modes of the one or more devices. The minimum residency time for the one or more low-power modes of the one or more devices identified at runtime may differ from a previously identified due to changes in conditions for the one or more processing devices. For example, the change in condition may include a change in one or more of the temperature of one or more device environments or of one or more device components, the operating speeds or frequencies of the one or more devices, or actual current leakage of the one or more devices. These changes in conditions may result in changes to the minimum residency time for the one or more low-power modes of the one or more devices. The processor system device may update the minimum residency time for the one or more low-power modes of the one or more devices in the memory (e.g., table 500 in FIG. 5). In some embodiments, the processor system device updating the minimum residency time for the one or more low-power modes of the one or more devices in block 708 may include the processor system, the framework module, or the low-power mode information update module.

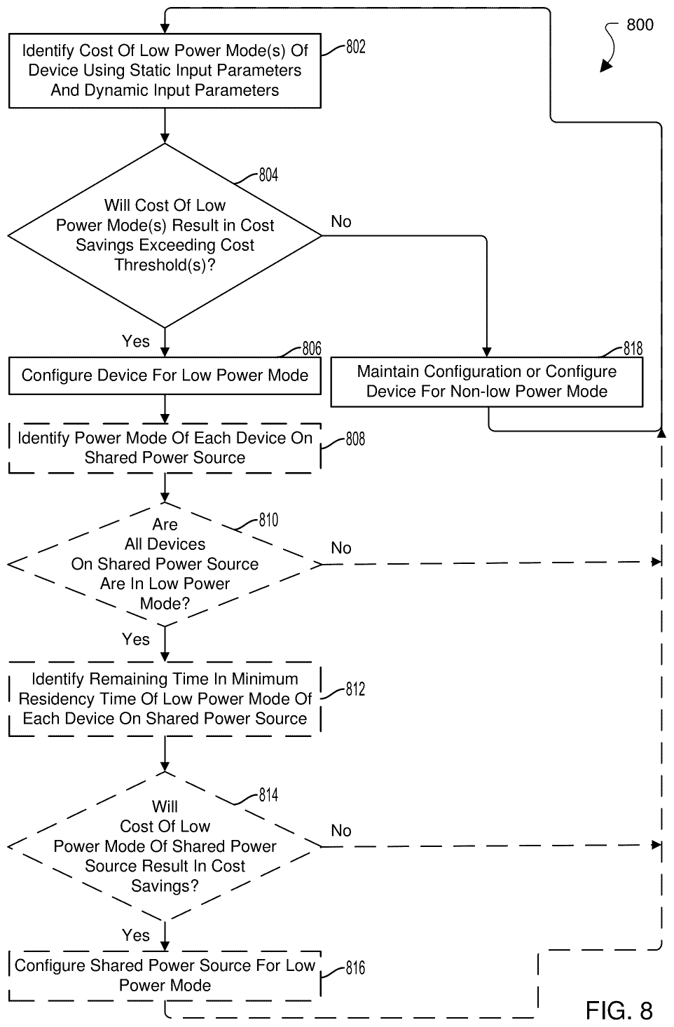

FIG. 8 is a process flow diagram illustrating an example method for process and temperature-aware processor system low-power mode selection according to an embodiment. With reference to FIGS. 1-8, the method 800 may be implemented in a computing device (e.g., computing device 10, 200 in FIGS. 1 and 2), in hardware (e.g., modules 206-220 in FIGS. 2 and 3), in software (e.g., modules 206-220 in FIGS. 2 and 3) executing in a processor system (e.g., processor system 14, 204, 300 in FIGS. 1-3), or in a combination of a software-configured processor and dedicated hardware, that includes other individual components, such as various memories/caches (e.g., memory 16, 36, 202 in FIGS. 1 and 2). In order to encompass the alternative configurations enabled in various embodiments, the hardware implementing the method 800 is referred to herein as a “processor system device.”

In block 802 processor system device may identify a cost of the one or more low-power modes of the one or mode devices (or processor systems) (e.g., processor system 14, 204, 300 in FIGS. 1-3) using static input parameters (e.g., static input parameters 304 in FIG. 3) and dynamic input parameters (e.g., dynamic input parameters 306 in FIG. 3). In some embodiments, the cost is energy consumed in transitioning into and out of the low-power mode and operating in the low-power mode for the duration of the minimum residency time. In some embodiments, the processor system device identifying the cost of the one or more low-power modes of the one or mode devices using the static input parameters and the dynamic input parameters in block 802 may include a processor system (e.g., processor system 14, 204, 300 in FIGS. 1-3), an idle governor module (e.g., idle governor module 212 in FIGS. 2 and 3), or a device cost identification module (e.g., device cost identification module 214 in FIG. 2). Implementing one or more algorithms, heuristics, etc., the processor system device may generate a cost of implementing the one or more low-power modes of the one or more devices based on one or more of the static parameter inputs and the dynamic parameter inputs.

The static input parameters may be retrieved from a memory (e.g., memory 16, 36, 202 in FIGS. 1 and 2), received from a component of a computing device (e.g., computing device 10, 200 in FIGS. 1 and 2), or calculated. The static input parameters may include, for example, entry latency and exit latency of the one or more low-power modes of the one or more devices, the minimum residency time of the one or more low-power modes of the one or more devices, a power down state, a timer functionality, a cost of the one or more low-power modes the one or more devices, etc. The dynamic input parameters may include, for example, a scheduler sleep length, a PM QoS, a prediction of low-power mode states, an enabled state, etc. The dynamic input parameters may be use-case-specific and may be different for different use cases. The dynamic input parameters may be provided to the processor system device from the memory, hardware, firmware, software, etc., of the computing device specifically for the use case.

In determination block 804, the processor system device may determine whether a cost of the one or more low-power modes will result in a cost savings as compared to one or more cost thresholds. In some embodiments, the processor system device making the determination in determination block 804 may be or include the processor system, the idle governor module, and/or the device cost identification module. In some embodiments, the cost savings may be in terms of resource use, such as energy, or performance impact, such as latency, of the one or more low-power modes of the processor system 204 in comparison to the one or more cost thresholds. In some embodiments, the one or more cost thresholds may be one or more preconfigured values. In some embodiments, each of the one or more cost thresholds may be associated with the one or more low-power modes of the one or more devices. In some embodiments, the one or more cost thresholds may be a cost of one or more of other power modes of the one or more devices. In some embodiments, the one or more of other power modes of the one or more devices may include non-low power modes, active modes, other low-power modes, etc.

The processor system device may determine whether the cost of implementing (e.g., transitioning to) the one or more low-power modes of one or more devices will result in cost savings as compared to the one or more cost thresholds. If the cost of the one or more low-power modes of the one or more devices does not exceed the one or more cost thresholds, this may indicate that a cost savings or benefit will result from implementing the one or more low-power modes of the one or more devices. If the cost of implementing the one or more low-power modes of the one or more devices will result in a cost savings compared to the one or more cost thresholds, the processor system device may select the one or more low-power modes of the one or more devices for implementation.

In response to determining that the cost of the one or more low-power modes will not result a cost savings compared to one or more cost thresholds (i.e., determination block 804=“No”), the processor system device may maintain a configuration of or configure the one or more devices for one or more non-low-power modes in block 818. To maintain the one or more devices in a current non-low power mode, the processor system device may configure appropriate hardware or software settings to configure the current power mode of the one or more devices or make no configuration changes to the appropriate hardware or software settings. In some embodiments, the processor system device maintaining the configuration of or configuring the one or more devices for the one or more non-low power modes in block 818 may include the processor system, the idle governor module, or a device power mode configuration module (e.g., device power mode configuration module 216 in FIG. 2).

In response to determining that the cost of the one or more low-power modes will result a cost savings as compared to one or more cost thresholds (i.e., determination block 804=“Yes”), the processor system device may configure the one or more devices for the one or more low-power modes of the one or more devices in block 806. Based on the one or more low-power modes of the one or more devices selected for implementation, the processor system device may configure appropriate hardware or software settings to configure the one or more low-power modes of the one or more devices. For example, to transition the one or more devices from one or more current power modes of the one or more devices to the one or more low-power modes of the one or more devices, the processor system device may configure appropriate hardware or software settings to configure the one or more low-power modes of the one or more devices. In some embodiments, the processor system device configuring the one or more devices for the one or more low-power modes of the one or more devices in block 806 may include the processor system, the idle governor module, or the device power mode configuration module.

In optional block 808, the processor system device may identify one or more power modes of each of the one or more devices on a shared power source. In some embodiments, the processor system device may retrieve power mode information for the multiple processor systems 204 from the memory 202. Based on the power mode information for the multiple processor systems 204, the processor system device may identify the power mode of each of multiple of the one or more devices sharing the power source. In some embodiments, the processor system device processor system device may signal each of the multiple of the one or more devices sharing the power source and identify the power mode of each of the multiple of the one or more devices based on the response from each of the multiple of the one or more devices. In some embodiments, the processor system device identifying the one or more power modes of each of the one or more devices on the shared power source in optional block 808 may include the processor system, the idle governor module, or a shared power source device cost identification module (e.g., shared power source device cost identification module 218 in FIG. 2).

In optional determination block 810, the processor system device may determine whether all of the one or more devices on the shared power source are in a low-power mode. Identifying whether all of the one or more devices on the shared power source are in a low-power mode may be based on the power mode of each of multiple of the one or more devices sharing the power source identified by the processor system device. In some embodiments, the processor system device identifying whether all of the one or more devices on the shared power source are in a low-power mode in optional determination block 810 may include the processor system, the idle governor module, or the shared power source device cost identification module.

In response to determining that all of the one or more devices on the shared power source are in a low-power mode (i.e., optional determination block 810=“Yes”), the processor system device may identify a remaining time in the low-power mode of each of the one or more devices on the shared power source in optional block 812. The time remaining in the low-power mode may be a time remaining in the minimum residency time for the low-power mode for each of the one or more devices on the shared power source. In some embodiments, the processor system device may retrieve the time remaining in the low-power mode for each of the one or more devices sharing the power source from the memory. In some embodiments, the processor system device may signal each of the one or more devices sharing the power source and identify the time remaining in the low-power mode of each of the one or more devices based on a response from each of the one or more devices. In some embodiments, the processor system device identifying the remaining time in the low-power mode of each of the one or more devices on the shared power source in optional block 812 may include the processor system, the idle governor module, or the shared power source device cost identification module.

In optional determination block 814, the processor system device may determine whether the cost of one or more low-power modes of the shared power source will result in cost savings if one of the low-power modes is implemented. In some embodiments, the determination in optional determination block 814 may be made by the processor system, the idle governor module, and/or the shared power source device cost identification module. Based at least in part on the time remaining in the low-power mode of each of the one or more devices on the shared power source, the processor system device may determine whether the cost of implementing the one or more low-power modes of the shared power source may result in cost savings. For example, the cost savings may be assessed in comparison to not implementing the one or more low-power modes of the shared power source. For example, the savings may be in terms of resource use, such as energy, or performance impact, such as latency, of the one or more low-power modes of the one or more devices in comparison to the one or more other power modes of the shared power source.

In some embodiments, determining whether the cost of implementing the one or more low-power modes of the shared power source of the one or more devices may result in cost savings based on the shortest time remaining in the low-power mode for one or more of the devices sharing the power source. In some embodiments, determining whether the cost of implementing the one or more low-power modes of the shared power source may result in a savings may be based on a statistical representation of the time remaining in the low-power mode for one or more of the devices sharing the power source. The processor system device may determine whether there would be cost savings from implementing the one or more low-power modes of the shared power source during the time remaining in the low-power mode for the one or more devices sharing the power source. For the cost of implementing a low-power mode of the shared power source identified as a savings, the processor system device may select the low-power mode of the shared power source for implementation.

In response to determining based on the cost of one or more low-power modes of the shared power source that implementing one of the low-power modes will result in cost savings (i.e., optional determination block 814=“Yes”), the processor system device may configure the shared power source for the low-power mode in optional block 816. Based on the low-power mode of the shared power source selected for implementation, the processor system device may configure appropriate hardware or software settings to configure the low-power mode of the shared power source. For example, to transition the shared power source from the current power mode of the shared power source to the low-power mode of the shared power source, the processor system device may configure appropriate hardware or software settings to configure the low-power mode of the shared power source. In some embodiments, the processor system device configuring the shared power source for the low-power mode in optional block 816 may include the processor system, the idle governor module, or a shared power source configuration module (e.g., shared power source configuration module 220 in FIG. 2).

Following maintaining the configuration of or configuring the one or more devices for the one or more non-low power modes in block 818; in response to determining that all of the one or more devices on the shared power source are not in a low-power mode (i.e., optional determination block 810=“No”); in response to identify that a cost of the one or more low-power modes of the shared power source is not a cost savings (i.e., optional determination block 814=“No”); or following configuring the shared power source for the low-power mode in optional block 816, the processor system device may again identify a cost of the one or more low-power modes of the one or more devices using static input parameters and dynamic input parameters in block 802 as described. In some embodiments, the processor system device identifying the cost of the one or more low-power modes of the one or more devices using the static input parameters and the dynamic input parameters in block 802 may include the processor system, the idle governor module, and/or the device cost identification module.

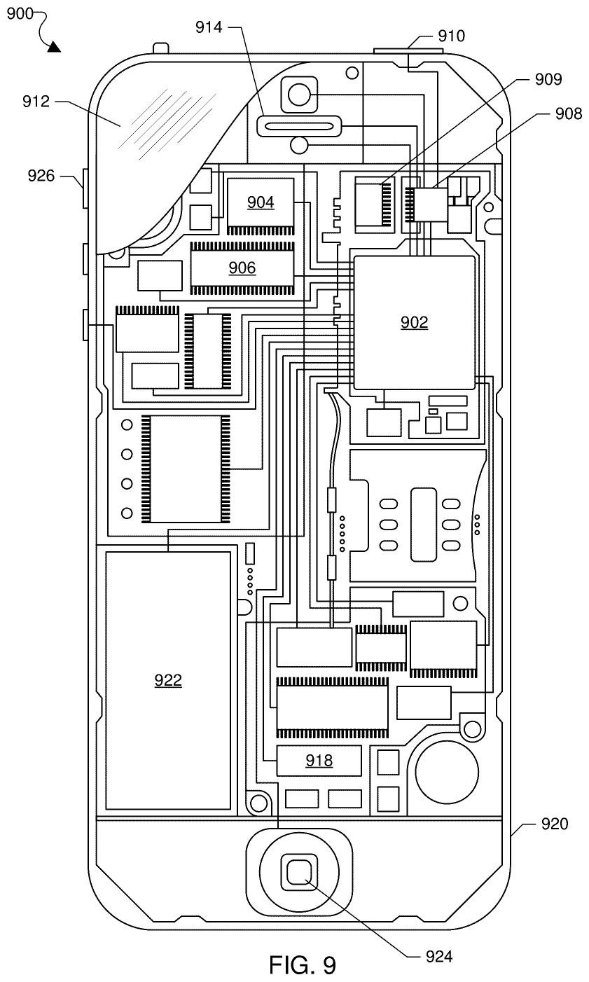

A system in accordance with the various embodiments (including, but not limited to, embodiments described above with reference to FIGS. 1-8) may be implemented in a wide variety of computing systems including mobile computing devices, an example of which suitable for use with the various embodiments is illustrated in FIG. 9. The mobile computing device 900 may include a processor 902 coupled to a touchscreen controller 904 and an internal memory 906. The processor 902 may be one or more multicore integrated circuits designated for general or specific processing tasks. The internal memory 906 may be a volatile or non-volatile memory and may also be secure and/or encrypted memory, unsecured and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM. The touchscreen controller 904 and the processor 902 may also be coupled to a touchscreen panel 912, such as a resistive-sensing touchscreen, capacitive-sensing touchscreen, infrared-sensing touchscreen, etc. Additionally, the display of the mobile computing device 900 need not have touchscreen capability.

The mobile computing device 900 may have one or more radio signal transceivers 908 (e.g., Peanut, Bluetooth, ZigBee, Wi-Fi, RF radio) and antennae 910, for sending and receiving communications, coupled to each other and/or to the processor 902. The processor 902 may also be coupled to a cellular network wireless modem 909 that enables communication via a cellular network (e.g., a 5G network) via the antenna 910. The transceivers 908 and antennae 910 may be used with the above-mentioned circuitry to implement the various wireless transmission protocol stacks and interfaces.

The mobile computing device 900 may include a peripheral device connection interface 918 coupled to the processor 902. The peripheral device connection interface 918 may be singularly configured to accept one type of connection, or may be configured to accept various types of physical and communication connections, common or proprietary, such as Universal Serial Bus (USB), FireWire, Thunderbolt, or PCIe. The peripheral device connection interface 918 may also be coupled to a similarly configured peripheral device connection port (not shown).

The mobile computing device 900 may also include speakers 914 for providing audio outputs. The mobile computing device 900 may also include a housing 920, constructed of a plastic, metal, or a combination of materials, for containing all or some of the components described herein. The mobile computing device 900 may include a power source 922 coupled to the processor 902, such as a disposable or rechargeable battery. The rechargeable battery may also be coupled to the peripheral device connection port to receive a charging current from a source external to the mobile computing device 900. The mobile computing device 900 may also include a physical button 924 for receiving user inputs. The mobile computing device 900 may also include a power button 926 for turning the mobile computing device 900 on and off.

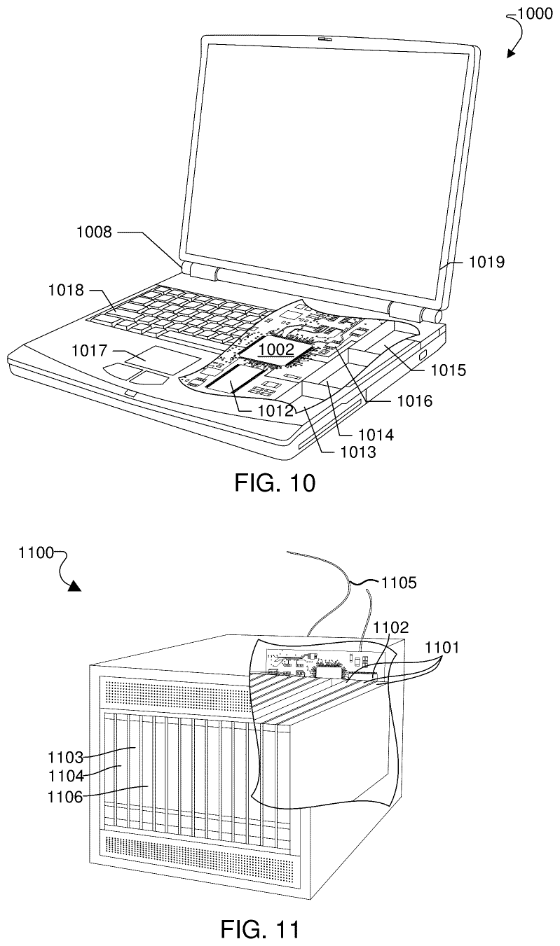

A system in accordance with the various embodiments (including, but not limited to, embodiments described above with reference to FIGS. 1-8) may be implemented in a wide variety of computing systems including a laptop computer 1000, an example of which is illustrated in FIG. 10. Many laptop computers include a touchpad touch surface 1017 that serves as the computer's pointing device, and thus may receive drag, scroll, and flick gestures similar to those implemented on computing devices equipped with a touch screen display and described above. A laptop computer 1000 will typically include a processor 1002 coupled to volatile memory 1012 and a large capacity nonvolatile memory, such as a disk drive 1013 of Flash memory. Additionally, the computer 1000 may have one or more antenna 1008 for sending and receiving electromagnetic radiation that may be connected to a wireless data link and/or cellular telephone transceiver 1016 coupled to the processor 1002. The computer 1000 may also include a floppy disc drive 1014 and a compact disc (CD) drive 1015 coupled to the processor 1002. In a notebook configuration, the computer housing includes the touchpad 1017, the keyboard 1018, and the display 1019 all coupled to the processor 1002. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-8) may also be implemented in fixed computing systems, such as any of a variety of commercially available servers. An example server 1100 is illustrated in FIG. 11. Such a server 1100 typically includes one or more multicore processor assemblies 1101 coupled to volatile memory 1102 and a large capacity nonvolatile memory, such as a disk drive 1104. As illustrated in FIG. 11, multicore processor assemblies 1101 may be added to the server 1100 by inserting them into the racks of the assembly. The server 1100 may also include a floppy disc drive, compact disc (CD) or digital versatile disc (DVD) disc drive 1106 coupled to the processor 1101. The server 1100 may also include network access ports 1103 coupled to the multicore processor assemblies 1101 for establishing network interface connections with a network 1105, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example systems, devices, or methods, further example implementations may include the example systems or devices discussed in the following paragraphs implemented as a non-transitory processor-readable storage medium having stored thereon processor-executable instructions configured to cause a processor of a computing device to perform the operations of the example systems, devices, or methods.

Example 1. Example 1. A method performed by a processor system of a computing device for managing power modes of the processor system, including: identifying a minimum residency time of at least one low-power mode of the processor system based on current leakage at runtime of the processor system; identifying a cost of the at least one low-power mode of the processor system based in part on the minimum residency time of the at least one low-power mode of the processor system; determining based on the identified cost of the at least one low-power mode whether transitioning to the at least one low-power mode of the processor system will result in cost savings compared to a cost of at least one other power mode of the processor system; and configuring the processor system for the at least one low-power mode of the processor system in response to determining that transitioning to the at least one low-power mode of the processor system will result in cost savings.

Example 2. The method of example 1, in which identifying a minimum residency time of at least one low-power mode of the processor system based on actual current leakage at runtime of the processor system includes identifying the minimum residency time of the at least one low-power mode of the processor system based on the actual current leakage at runtime of the processor system and an operating speed at runtime of the processor system.

Example 3. The method of example 2, further including: identifying the actual current leakage at runtime of the processor system; and updating the minimum residency time of the at least one low-power mode of the processor system based on the actual current leakage at runtime of the processor system.

Example 4. The method of any of examples 1-3, further including: identifying an expected current leakage of the processor system; and identifying a minimum residency time of the at least one low-power mode of the processor system based on the expected current leakage of the processor system.

Example 5. The method of any of examples 1-4, further including updating the minimum residency time of the at least one low-power mode of the processor system based on an expected current leakage of the processor system based on the minimum residency time of the at least one low-power mode of the processor system based on the actual current leakage at runtime of the processor system.

Example 6. The method of any of examples 1-5, in which: the at least one low-power mode of the processor system includes a first low-power mode and a second low-power mode; determining based on the identified cost of the at least one low-power mode whether transitioning to the at least one low-power mode of the processor system will result in cost savings compared to the cost of the at least one other power mode of the processor system includes determining whether transitioning to the second low-power mode results in an energy savings as compared to transitioning to the first low-power mode; and configuring the processor system for the at least one low-power mode of the processor system in response to determining that transitioning to the at least one low-power mode of the processor system will result in cost savings includes configuring the processor system for the second low-power mode in response to identifying that the cost of the second low-power mode will result in cost savings as compared to transitioning to the first low-power mode.

Example 7. The method of any of examples 1-6, further including: identifying that each of a plurality of processor systems connected to a shared power source are configured in a low-power mode, the plurality of processor systems including the processor system; identifying a remaining time in a minimum residency time of the low-power mode of each of the plurality of processor systems, the minimum residency time of the low-power mode of each of the plurality of processor systems including the minimum residency time of the at least one low-power mode of the processor system; determining whether transitioning to a low-power mode of the shared power source will result in cost savings as compared to transitioning to the low-power mode of each of the plurality of processor systems based on the remaining time in the minimum residency time of the low-power mode of each of the plurality of processor systems; and configuring the shared power source for the low-power mode of the shared power source in response to determining that transitioning to a low-power mode of the shared power source will result in cost savings as compared to transitioning to the low-power mode of each of the plurality of processor systems.

Example 8. The method of any of examples 1-7, in which the cost is energy consumed in transitioning into the low-power mode and operating in the low-power mode for a duration of the minimum residency time.

Computer program code or “program code” for execution on a programmable processor for carrying out operations of the various embodiments may be written in a high-level programming language such as C, C++, C #, Smalltalk, Java, JavaScript, Visual Basic, a Structured Query Language (e.g., Transact-SQL), Perl, or in various other programming languages. References to program code or programs stored on a computer-readable storage medium in this application may include machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disc, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method performed by a processor system of a computing device for managing power modes of the processor system, comprising:
identifying a minimum residency time of at least one low-power mode of the processor system based on current leakage at runtime of the processor system;
identifying a cost of the at least one low-power mode of the processor system based in part on the minimum residency time of the at least one low-power mode of the processor system;
determining based on the identified cost of the at least one low-power mode whether transitioning to the at least one low-power mode of the processor system will result in cost savings compared to a cost of at least one other power mode of the processor system; and
configuring the processor system for the at least one low-power mode of the processor system in response to determining that transitioning to the at least one low-power mode of the processor system will result in cost savings.

2. The method of claim 1, wherein identifying a minimum residency time of at least one low-power mode of the processor system based on actual current leakage at runtime of the processor system comprises identifying the minimum residency time of the at least one low-power mode of the processor system based on the actual current leakage at runtime of the processor system and an operating speed at runtime of the processor system.

3. The method of claim 2, further comprising:
identifying the actual current leakage at runtime of the processor system; and
updating the minimum residency time of the at least one low-power mode of the processor system based on the actual current leakage at runtime of the processor system.

4. The method of claim 1, further comprising:
identifying an expected current leakage of the processor system; and
identifying a minimum residency time of the at least one low-power mode of the processor system based on the expected current leakage of the processor system.

5. The method of claim 3, further comprising updating the minimum residency time of the at least one low-power mode of the processor system based on an expected current leakage of the processor system based on the minimum residency time of the at least one low-power mode of the processor system based on the actual current leakage at runtime of the processor system.

6. The method of claim 1, wherein:
the at least one low-power mode of the processor system includes a first low-power mode and a second low-power mode;
determining based on the identified cost of the at least one low-power mode whether transitioning to the at least one low-power mode of the processor system will result in cost savings compared to the cost of the at least one other power mode of the processor system comprises determining whether transitioning to the second low-power mode results in an energy savings as compared to transitioning to the first low-power mode; and
configuring the processor system for the at least one low-power mode of the processor system in response to determining that transitioning to the at least one low-power mode of the processor system will result in cost savings comprises configuring the processor system for the second low-power mode in response to identifying that the cost of the second low-power mode will result in cost savings as compared to transitioning to the first low-power mode.

7. The method of claim 1, further comprising:
identifying that each of a plurality of processor systems connected to a shared power source are configured in a low-power mode, the plurality of processor systems including the processor system;
identifying a remaining time in a minimum residency time of the low-power mode of each of the plurality of processor systems, the minimum residency time of the low-power mode of each of the plurality of processor systems including the minimum residency time of the at least one low-power mode of the processor system;
determining whether transitioning to a low-power mode of the shared power source will result in cost savings as compared to transitioning to the low-power mode of each of the plurality of processor systems based on the remaining time in the minimum residency time of the low-power mode of each of the plurality of processor systems; and
configuring the shared power source for the low-power mode of the shared power source in response to determining that transitioning to a low-power mode of the shared power source will result in cost savings as compared to transitioning to the low-power mode of each of the plurality of processor systems.

8. The method of claim 1, wherein the cost is energy consumed in transitioning into the low-power mode and operating in the low-power mode for a duration of the minimum residency time.

9. A computing device, comprising:
a processor system comprising a framework module and an idle governor module, wherein:
the framework module is configured to:
identify a minimum residency time of at least one low-power mode of the processor system based on current leakage at runtime of the processor system; and
identify a cost of the at least one low-power mode of the processor system based in part on the minimum residency time of the at least one low-power mode of the processor system; and
the idle governor module is configured to:
determine based on the identified cost of the at least one low-power mode whether transitioning to the at least one low-power mode of the processor system will result in cost savings compared to a cost of at least one other power mode of the processor system; and
configure the processor system for the at least one low-power mode of the processor system in response to determining that transitioning to the at least one low-power mode of the processor system will result in cost savings.

10. The computing device of claim 9, wherein identifying a minimum residency time of at least one low-power mode of the processor system based on actual current leakage at runtime of the processor system comprises identifying the minimum residency time of the at least one low-power mode of the processor system based on the actual current leakage at runtime of the processor system and an operating speed at runtime of the processor system.

11. The computing device of claim 10, further comprising:
identifying the actual current leakage at runtime of the processor system; and
updating the minimum residency time of the at least one low-power mode of the processor system based on the actual current leakage at runtime of the processor system.

12. The computing device of claim 9, further comprising:
identifying an expected current leakage of the processor system; and
identifying a minimum residency time of the at least one low-power mode of the processor system based on the expected current leakage of the processor system.

13. The computing device of claim 3, further comprising updating the minimum residency time of the at least one low-power mode of the processor system based on an expected current leakage of the processor system based on the minimum residency time of the at least one low-power mode of the processor system based on the actual current leakage at runtime of the processor system.

14. The computing device of claim 9, wherein:
the at least one low-power mode of the processor system includes a first low-power mode and a second low-power mode;
determining based on the identified cost of the at least one low-power mode whether transitioning to the at least one low-power mode of the processor system will result in cost savings compared to the cost of the at least one other power mode of the processor system comprises determining whether transitioning to the second low-power mode results in an energy savings as compared to transitioning to the first low-power mode; and
configuring the processor system for the at least one low-power mode of the processor system in response to determining that transitioning to the at least one low-power mode of the processor system will result in cost savings comprises configuring the processor system for the second low-power mode in response to identifying that the cost of the second low-power mode will result in cost savings as compared to transitioning to the first low-power mode.

15. The computing device of claim 9, further comprising:
identifying that each of a plurality of processor systems connected to a shared power source are configured in a low-power mode, the plurality of processor systems including the processor system;
identifying a remaining time in a minimum residency time of the low-power mode of each of the plurality of processor systems, the minimum residency time of the low-power mode of each of the plurality of processor systems including the minimum residency time of the at least one low-power mode of the processor system;
determining whether transitioning to a low-power mode of the shared power source will result in cost savings as compared to transitioning to the low-power mode of each of the plurality of processor systems based on the remaining time in the minimum residency time of the low-power mode of each of the plurality of processor systems; and
configuring the shared power source for the low-power mode of the shared power source in response to determining that transitioning to a low-power mode of the shared power source will result in cost savings as compared to transitioning to the low-power mode of each of the plurality of processor systems.

16. The computing device of claim 9, wherein the cost is energy consumed in transitioning into the low-power mode and operating in the low-power mode for a duration of the minimum residency time.

17. A non-transitory processor-readable medium having stored thereon processor-executable instructions configured to cause a processor of a computing device to perform operations for managing power modes of a processor system comprising:
identifying a minimum residency time of at least one low-power mode of the processor system based on current leakage at runtime of the processor system;
identifying a cost of the at least one low-power mode of the processor system based in part on the minimum residency time of the at least one low-power mode of the processor system;
determining based on the identified cost of the at least one low-power mode whether transitioning to the at least one low-power mode of the processor system will result in cost savings compared to a cost of at least one other power mode of the processor system; and
configuring the processor system for the at least one low-power mode of the processor system in response to determining that transitioning to the at least one low-power mode of the processor system will result in cost savings.

18. The non-transitory processor-readable medium of claim 17, wherein the stored processor-executable instructions are further configured to cause the processor of the computing device to perform operations further comprising:
identifying the actual current leakage at runtime of the processor system; and
updating the minimum residency time of the at least one low-power mode of the processor system based on the actual current leakage at runtime of the processor system.

19. The non-transitory processor-readable medium of claim 17, wherein the stored processor-executable instructions are further configured to cause the processor of the computing device to perform operations further comprising:
identifying an expected current leakage of the processor system; and
identifying a minimum residency time of the at least one low-power mode of the processor system based on the expected current leakage of the processor system.

20. The method of claim 19, wherein the stored processor-executable instructions are further configured to cause the processor of the computing device to perform operations further comprising updating the minimum residency time of the at least one low-power mode of the processor system based on an expected current leakage of the processor system based on the minimum residency time of the at least one low-power mode of the processor system based on the actual current leakage at runtime of the processor system.
